(19) United States
(12) Patent Application Publication
(10) Pub. No.: US 2008/0289659 A1
(43) Pub. Date: Nov. 27, 2008

(54) CLEANING KIT FOR REMOVING RESIDUAL MATTER FROM INTERIOR OF A NARROW NECKED CONTAINER

(75) Inventor: Armen G. Gunjian, Plattsburgh, NY (US)

Correspondence Address: BURR & BROWN, PO BOX 7068, SYRACUSE, NY, 13261-7068, US

(73) Assignee: Brushtech, Inc., Plattsburgh, NY (US)

(21) Appl. No.: 11/753,887

(22) Filed: May 25, 2007

(51) Int. Cl. B08B 3/04; A46B 13/04

(52) U.S. Cl. 134/22.18; 134/60; 15/21.1

(57) ABSTRACT

A cleaning kit for removing residual matter from the interior of a narrow necked container includes an enclosure, solid cleaning media, a first closure member, and a second closure member. The enclosure has an interior volume bounded at least in part by first and second ends. The first end having a first opening, and the second end having a second opening that is larger than the first opening. The cleaning media is positioned within the interior of the enclosure. A first closure member is removably positioned to obstruct the flow of the solid cleaning media out of the enclosure through the first opening while allowing the flow of fluid from the interior volume of the enclosure through the first opening. The second closure member is removably positioned to obstruct the flow of the cleaning media out of the enclosure through the second opening.

### FIELD OF THE INVENTION

The present invention relates to a kit for removing residual matter from the interior of a narrow necked container.

### BACKGROUND OF THE INVENTION

Narrow necked containers have been in use for centuries due to their ability to hold relatively large quantities of a liquid with a relatively small opening. The smallness of the opening is of great benefit for purposes of pouring from the container and sealing the container. The relative smallness of the opening is, however, a great disadvantage when the container is to be cleaned before use or reuse.

The size of the neck of the container prevents many traditional types of cleaning, such as with hands or a dish cloth, because these items are too large for entry into the interior portion of the container through the narrow neck. Further, the use of a cleaning brush also fails, because a brush having a small enough diameter to pass though the narrow neck is likely of insufficient size to contact the inner walls and corners of the remaining parts of the container. As a result, many narrow necked containers, such as beer bottles and wine bottles, are simply discarded or crushed for recycling after one use. Other narrow necked containers, such as fine vases and decanters, are typically cleaned using crude techniques that include soaking and swirling harsh cleaning solutions within the interior of the bottle.

Many people tasked with cleaning narrow necked containers over the centuries have resorted to a complicated process of swirling solid particles or media with cleaning solutions, such as water, if the container has a tough, stubborn residue on its inner surfaces. As one can imagine, the media has often been crude items such as small stones or sand. One can easily imagine the harm created to the inside of a fine crystal decanter by swirling small stones therein. Even so, the soiled decanter may be equally useless with dark residue adhered to the inner walls.

More recently, it has been known to use more sensible media other than stones and sand, such as small steel balls or small glass balls, with the cleaning solution in order to remove stubborn residue. Using such media may be safer to the internal finish of a fine vase or decanter, but managing the use and storage of the media remains a substantial burden. For example, the use of small steel balls, such as commonly available BB's, work very well when combined with water or other cleaning solutions to remove residue. Anyone who has handled such cleaning media can attest to the fact that the act of gathering and storing such media is a difficult task.

For example, a user must be dexterously adept to pass a sufficient quantity of small steel balls through the small opening within the narrow necked container without losing at least a few into the sink and onto the floor. After the cleaning within the narrow necked bottle is accomplished, above-average dexterity is further required to catch all of small steel balls exiting the bottle without losing the balls or spreading the cleaning water including the residue throughout the kitchen and on the user's clothes. As one can easily imagine, a person of limited dexterity or of advanced age could have significant problems using and managing the small steel balls before, during and after the cleaning process. The user's problems could increase greatly if the small steel balls are allowed to fall onto the floor along with the liquids causing the floor to become dangerously slippery.

For at least the reasons explained above, it is clear that a new system and method for cleaning a narrow necked container is required to solve the above problems, while, at the same time reduce the amount of waste generated by discarding necked bottles after only one use.

### SUMMARY OF THE INVENTION

It is an object of the present invention to overcome the problems with managing media used for cleaning residual matter from the interior of a narrow necked container. It is another object of the present invention to provide a user with a device and method for passing the media to and from the narrow necked container and safely storing the media while not in use.

In accordance with one embodiment of the present invention, a cleaning kit for removing residual matter from the interior of a narrow necked container is provided that includes an enclosure having an interior volume bounded at least in part by first and second ends, the first end having a first opening, and the second end having a second opening that is larger than the first opening. Solid cleaning media is positioned within the interior of the enclosure. A first closure member is removably positioned to obstruct the flow of the solid cleaning media out of the enclosure through the first opening while allowing the flow of fluid from the interior volume of the enclosure through the first opening. A second closure member is removably positioned to obstruct the flow of the cleaning media out of the enclosure through the second opening.

The resultant cleaning kit first provides the user with an enclosure that, in coordination with the first and second closure members, can be used to easily and safely pass solid media into the narrow necked container, collect the solid media within the enclosure while passing cleaning fluids there though, and storing the solid media.

Preferably, the first closure member includes a first portion having an outer diameter that is substantially similar to the diameter of the first opening and a second portion that is accessible within the interior volume of the enclosure. According to one embodiment of the present invention, the first portion of the first closure member is a fibrous brush.

Preferably, the second portion of the first closure member is sized so as to prevent the first closure member from passing through the first opening. According to one embodiment of the present invention, the second portion of the first closure member is an extension of the wire used to retain fibers present in the first portion of the first closure member.

Preferably, the solid cleaning media includes a plurality of media objects selected from spheres, cylinders, and polygons. Preferably, the solid cleaning media is made of at least one of a metal, a ceramic, and a plastic. In accordance with one embodiment of the present invention, the solid cleaning media is a large quantity (e.g., at least 300) small stainless steel balls.

Preferably, the interior volume of the enclosure is further bounded by a sidewall extending between the first and second ends. In accordance with one embodiment of the present invention, the sidewall includes a first portion extending from the first end and a second portion extending from the second end and merging with the first portion at a boundary therebetween. In accordance with one embodiment of the present invention, the first portion tapers outwardly as it extends from the first end toward the boundary, and the second portion tapers outwardly to a greater extent as it extends from the boundary toward the second end.

In accordance with another embodiment of the present invention, a cleaning method for removing residual matter from the interior of a narrow necked container includes the steps of providing an enclosure having an interior volume bounded at least in part by first and second ends, the first end having a first opening, and the second end having a second opening that is larger than the first opening, providing solid media, and providing a first closure member. The method further includes the steps of positioning the media in the interior of the narrow necked container and adding cleaning fluid to the interior of the narrow necked container. The method further includes the steps of positioning the first closure member within the interior volume of the enclosure, pouring at least a portion of the cleaning fluid and the media through the interior volume of the enclosure, and retaining the media within the interior volume.

In accordance with one embodiment of the present invention, the first opening of the enclosure is inserted into the narrow necked container prior to positioning the media in the interior of the narrow necked container. In accordance with another embodiment of the present invention, the first closure member is positioned within the interior volume of the enclosure before the step of pouring a portion of the cleaning fluid and the media through the interior volume of the enclosure.

### BRIEF DESCRIPTION OF THE DRAWINGS

For a fuller understanding of the nature and objects of the invention, reference should be made to the following detailed description of a preferred mode of practicing the invention, read in connection with the accompanying drawings in which:

FIG. 1 is a sectional view of a kit for removing residual matter from the interior of a narrow necked container in accordance with one embodiment of the present invention;

FIG. 2 is an orthogonal view of the kit shown in FIG. 1;

FIG. 3 is a sectional view of a second embodiment of the present invention;

FIG. 4 is a sectional view of a third embodiment of the present invention;

FIG. 5 is a sectional view of a fourth embodiment of the present invention;

FIG. 6 is a sectional view of an initial use step according to an embodiment of the present invention;

FIG. 7 is a sectional view of an intermediate use step according to an embodiment of the present invention;

FIG. 8 is a sectional view of an intermediate use step according to an embodiment of the present invention;

FIG. 9 is a sectional view of an intermediate use step according to an embodiment of the present invention; and

FIG. 10 is a sectional view of a final use step according to an embodiment of the present invention.

### DETAILED DESCRIPTION OF THE INVENTION

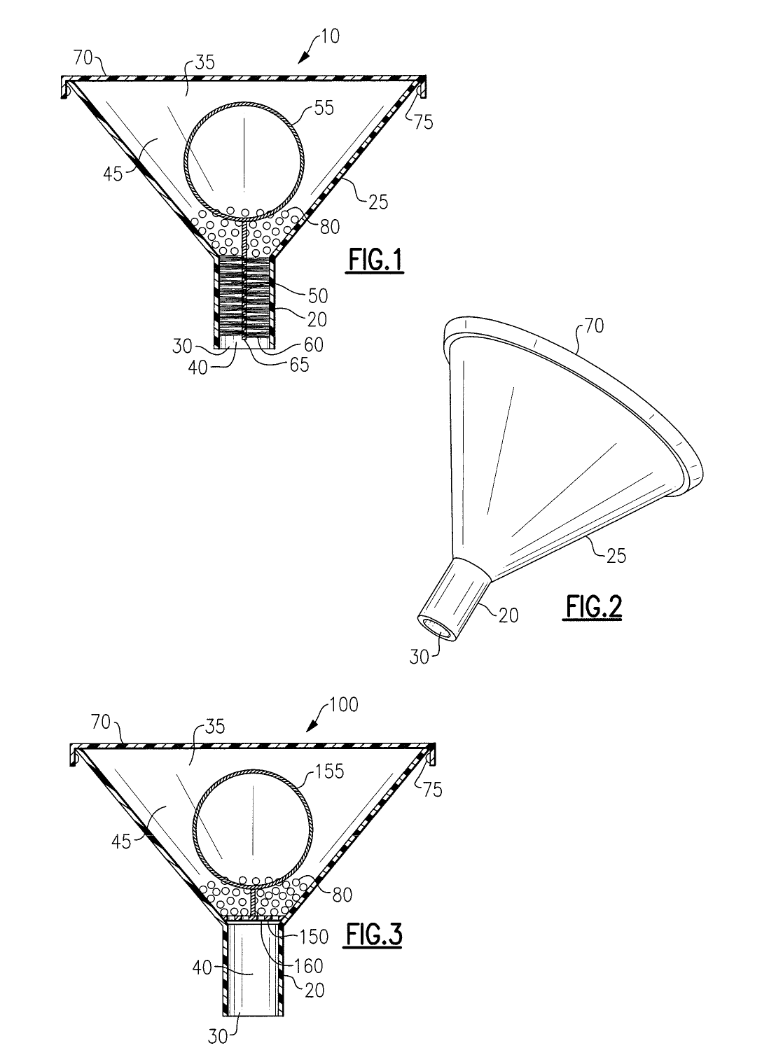

FIGS. 1 and 2 show a cleaning kit for removing residual matter from the interior of a narrow necked container in accordance with one embodiment according to the present invention. The kit 10 shown in FIG. 1 contains an enclosure having a first sidewall portion 20 and an adjoining second sidewall portion 25. Both the first sidewall portion 20 and the second sidewall portion 25 are formed from a continuous plastic resin material (e.g., high density polyethylene). The sidewall portions 20, 25 can, however, be made of any dimensionally stable materials, such as metal, glass, or other polymer as is well known in the art. Further, the first sidewall portion 20 and the second sidewall portion 25 can be made from separate pieces of the same or different materials.

The first sidewall portion 20 surrounds a first interior volume 40 and has a relatively constant diameter throughout its length between the adjoining second sidewall portion 25 and a first opening 30. The inside diameter of the first sidewall portion 20 can also be tapered as long as the first opening 30 remains small enough to focus a flow of materials into the narrow necked container. Such variations will be discussed more fully below.

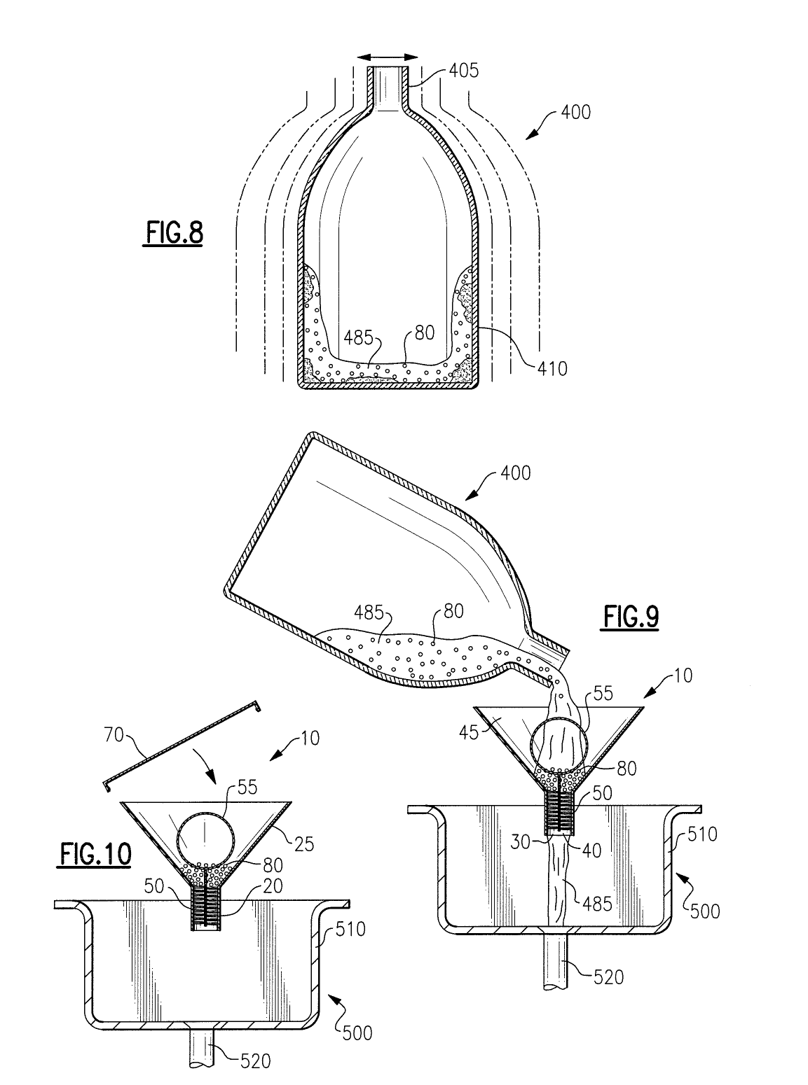

The second sidewall portion 25 surrounds a second interior volume 45 and tapers from a relatively large internal diameter at a second opening 35 opposite the first opening 30 to a relatively small diameter at a point adjacent the first sidewall portion 20. While the second sidewall portion 25 in the embodiment shown in FIGS. 1 and 2 tapers at a constant rate, it should be understood that the second sidewall portion 25 can have various other shapes based on a designer's tastes and a consumer's aesthetic desires. The interior volume 45 is of sufficient size to hold an amount of media 80 and is of sufficient size to allow for the easy passage of liquid 485 (FIG. 9) and media 80 into the second interior volume 45 from the narrow necked container 400 (FIG. 9).

A portion of the first interior volume 40 is filled with a first closure member 50, which, in the case of the present embodiment, is a fibrous brush-like member. The polymer fibers 60 of the first closure member 50 are held together and are held in the desired shape by stainless steel retaining wires 65. While the fibers 60 used in the present embodiment are made from nylon to eliminate any possible corrosion, the fibers 60 of the first closure member can be made of any of the well-known fiber materials, such as carbon steel, stainless steel, bronze, or brass. Similarly, while the retaining wires 65 used in the present embodiment are made from stainless steel, the retaining wire can be made of any well-known wire materials, such as plastic polymers, carbon steel, bronze, or brass. The fibers 60 are spaced apart such that they allow the flow of liquids and small amounts of residue or other debris through the first interior volume 40 and out through the first opening 30. The first closure member 50, however, precludes the passage of the media 80 out though the first opening 30.

The first closure member 50 further includes a second portion or handle portion 55 that is accessible from within the second interior volume 45. The handle portion 55 of the present embodiment is an extension of the retaining wires 65 used to retain the fibers 60. The retaining wires 65 of the handle portion 55 are twisted together in a spiral pattern to give the handle portion 55 greater dimensional stability. The handle portion 55 can also be made of a material different from retaining wires 65 and attached to the retaining wires 65 in a manner using adhesives as is well known in the art.

The handle 55 is sized such that a user can easily grasp it to remove the first closure member 50. Preferably, the handle 55 is sized small enough such that it does not extend beyond the second interior volume, but it is also sized large enough that the handle 55 will resist the inadvertent displacement of the first closure member 50 while a second closure member 70 is secured to the second sidewall portion 25. Preferably the handle 55 is large enough to contact the second closure member 70 before the fibers 60 of the first closure member 50 withdraw entirely from the first interior volume 40. Accordingly the media 80 will be retained within the second interior volume 45 even if the kit 10 is vibrated during shipment and subsequent use.

The second closure member 70 is removably attached to the second sidewall portion 25 to close the second opening 35 from the passage of media 80. The second closure member of the present embodiment can be made of the same material that is used to make the first sidewall portion 20 and the second sidewall portion 25 of the enclosure. Alternatively, the second closure member can be made using any of the materials discussed above in relation to the enclosure. Further, the sidewalls 20, 25 of the enclosure can be made of a material that is different from the material of the second closure member 70.

A small annular protrusion 75 is formed around an inner circumferential surface of the second closure member 70 to resist the removal of the second closure member 70 and an inadvertent passage of the media 80 through the second opening 35. The protrusions 75 can be in the form of an annular ring or individual protrusions as is well known in the art. The annular protrusion 75 requires a deflection of the second closure member 70, the second sidewall portion 25, or both for the separation or installation of the second closure member 70 with the second sidewall portion 25.

The media 80 used in the present embodiment is a quantity of stainless steel spheres having a diameter of 0.18″. The media 80 can be any small objects that are small enough to pass through the first opening 30 and into the necked container. Media 80 that is too small may not have sufficient inertia to efficiently remove residue from the interior surfaces of the necked container. Media 80 that is too large may have sufficient inertial potential to crack or otherwise break the narrow necked container upon insertion of the media into the necked container. The size of the media 80 can change without affecting the weight of the media by varying the material to a ceramic or glass material from the metal used in the present embodiment. Further, the shape of the media 80 can include a wide array of shapes such as cylinders, pyramids, polygons, amorphous, etc. Similarly, the media 80 can be hollow or solid based on the size and weight requirements determined by a user. Further, a variety of different shapes and weights may be used at the same time to offer differing cleaning benefits to the user.

FIG. 3 shows a cleaning kit 100 in accordance with an alternate embodiment according to the present invention. The kit 100 includes a first closure member 150 having apertures 160 passing there though. The first closure member 150 can be made of a plastic resin and is shaped to conform generally to an inner surface of the second sidewall portion 25. Alternatively, the first closure member can be shaped and sized to conform to an inner surface of the first sidewall portion 20. The apertures 160 are sized such that they are smaller in size than the media 80 so that fluid and small particles can pass through the first closure member and media is retained within the interior volume 45.

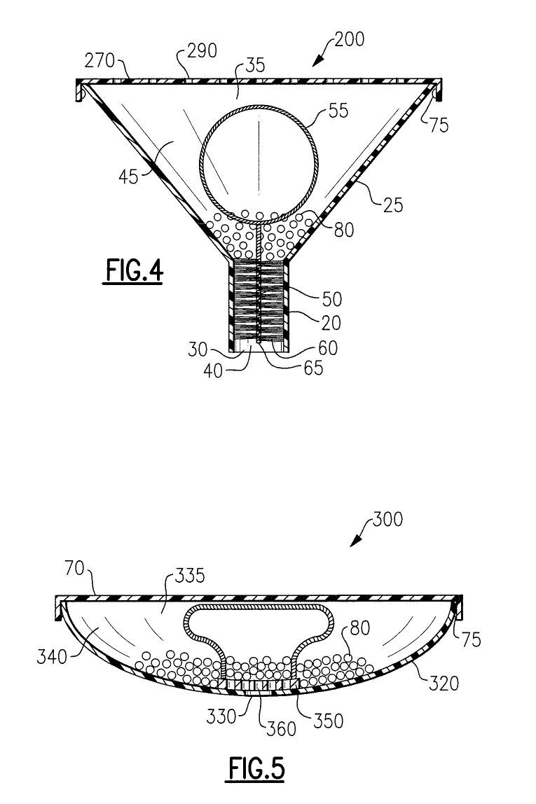

FIG. 4 shows a cleaning kit 200 in accordance with another embodiment according to the present invention. The kit 200 includes a second closure member 270 containing apertures 290, each having a diameter smaller than the media 80. The apertures 290 allow fluid and small particles to pass through the second closure member 270 while retaining the media within the second interior volume 45. The apertures 190 in the second closure member 270 allow a user to add water and other cleaning fluids to the second interior volume to help clean or rinse the media 80. Further, the apertures allow water and other cleaning fluid to drip from the media 80 and pass out of the second interior volume while the kit 200 is oriented so as to rest on the second closure member 270.

FIG. 5 shows a cleaning kit 300 in accordance with another embodiment according to the present invention. The kit 300 includes an enclosure having one sidewall portion 320 that forms both a first opening 330 and a second opening 335 opposite the first opening 330. Between the first opening 330 and the second opening 335, the sidewall portion 320 bounds an interior volume 340. While the shape of the sidewall portion 320 is shown to be arcuate, the shape of the sidewall portion in the kit 300 can be any creative shape that is desirable to the designer and/or the consumer. It should be noted, however, that the shape should allow for the presence of a first opening 330 that is small enough to focus fluid and media 80 into the neck of a necked container and be located at a lowermost point on the interior volume 340 so that all fluid and media 80 located within the interior volume 340 can pass freely through the first opening 330 upon removal of a first closure member 350.

The first closure member 350 is positioned adjacent to the first opening 330 and contains apertures 360 sized to allow fluid and small particles to pass though while media 80 is restricted from passing through the apertures 360. Accordingly, when the first closure member 350 is in place against the sidewall portion 320, the media 80 is retained within the interior volume 345. The first closure member also 350 includes a handle 355 sized to trap the first closure member between the sidewall portion 320 in the area of the first opening 330 and the second closure member 70.

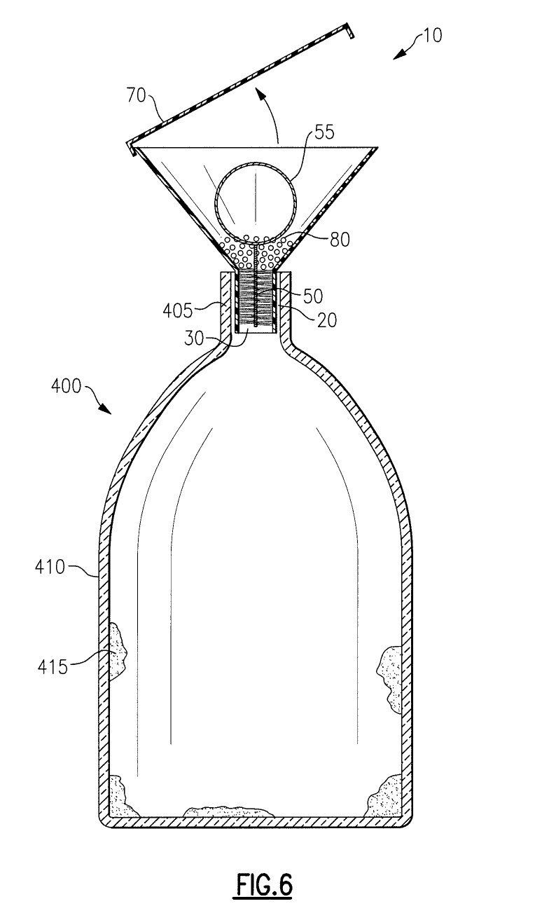

FIGS. 6-10 show a process of using the kit 10 according to one embodiment of the present application. As shown in FIG. 6, the kit 10 is inserted into a narrow necked container 400 having a neck 405 a body 410, and residue 415 to be removed. The first sidewall portion 20 extends into an inner portion of the neck 405 to ensure that any fluid and media passing through the first opening 30 passes into the necked container 400. At this point, the second closure member 70 is removed to allow access to the handle 55 of the first closure member 50.

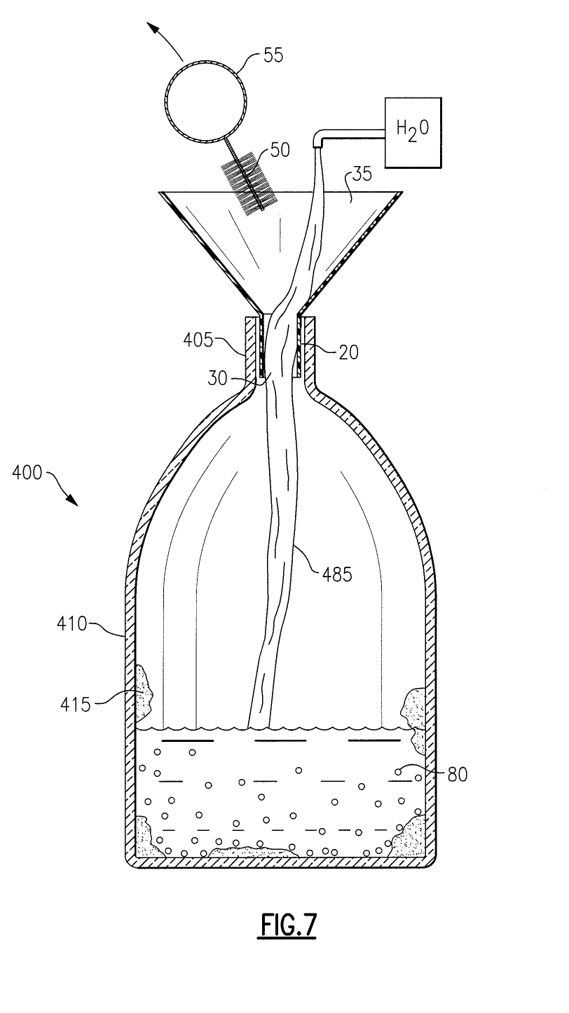

As shown in FIG. 7, the first closure member 50 is removed allowing the media 80 to flow into the body 410 of the necked container 400. To avoid damage to the necked container 400 caused by the media impacting the body 410, water and/or other cleaning solutions 485 can be added to the necked container 400 through the second opening 35 and the first opening 30 before the first closure member 50 is removed from the first interior volume. The presence of the liquid 485 in the body 410 softens the impact of the media 80 onto the body 410.

As shown in FIG. 8, the mixture of media 80 and liquid 485 is swirled and shaken, within the body 410 to remove any residue (FIG. 7) from the internal surfaces of the necked container 400. The media 80 impacts the walls of the necked container to loosen and pulverize the residue into particles that can be suspended into the liquid 485.

As shown in FIG. 9, the first closure member 50 is replaced into the first interior member 40, and the kit 10, with the second closure member 35 removed, is held over a sink 500 having sidewalls 510 and a drain 520. The first closure member 50 allows the liquid 485 to pass through the first opening 30 and into the drain while the media 80 is retained within the second interior volume 45.

As shown in FIG. 10, the second closure member 70 is replaced onto the second sidewall portion 25 to retain both the media 80 and the first closure member 50. The kit 10 can be allowed to dry and be stored in this configuration.

While the present invention has been particularly shown and described with reference to the preferred mode as illustrated in the drawings, it will be understood by one skilled in the art that various changes may be effected therein without departing from the spirit and the scope of the invention as defined by the claims.

What is claimed is:

1. A cleaning kit for removing residual matter from the interior of a narrow necked container, said cleaning kit comprising:
an enclosure having an interior volume bounded at least in part by first and second ends, the first end having a first opening, and the second end having a second opening that is larger than the first opening;
solid cleaning media positioned within the interior of the enclosure,
a first closure member removably positioned to obstruct the flow of the solid cleaning media out of the enclosure through the first opening while allowing the flow of fluid from the interior volume of the enclosure through the first opening; and
a second closure member removably positioned to obstruct the flow of the cleaning media out of the enclosure through the second opening.

2. The cleaning kit according to claim 1, wherein the first closure member comprises a first portion having an outer diameter that is substantially similar to the diameter of the first opening.

3. The cleaning kit according to claim 2, wherein the first closure member further comprises a second portion that is accessible within the interior volume of the enclosure.

4. The cleaning kit according to claim 3, wherein the second portion is sized so as to prevent the first closure member from passing through the first opening.

5. The cleaning kit according to claim 1, wherein the second closure member allows the flow of fluid from the interior volume of the enclosure through the second opening.

6. The cleaning kit according to claim 2, wherein the first portion of the first closure member is a fibrous brush.

7. The cleaning kit according to claim 3, wherein the second portion of the first closure member comprises wire used to retain fibers present in the first portion of the first closure member.

8. The cleaning kit according to claim 1, wherein the solid cleaning media, comprises a plurality of media objects selected from spheres, cylinders and polygons.

9. The cleaning kit according to claim 8, wherein the media objects are made of at least one of a metal, a ceramic, and a plastic.

10. The cleaning kit according to claim 1, wherein the interior volume of the enclosure is further bounded by a sidewall extending between the first and second ends.

11. The cleaning kit according to claim 10, wherein the sidewall comprises a first portion extending from the first end and a second portion extending from the second end and merging with the first portion at a boundary therebetween, wherein the first portion has a substantially constant diameter and the second portion gradually increases in diameter as it extends away from the boundary.

12. The cleaning kit according to claim 10, wherein the sidewall comprises a first portion extending from the first end and a second portion extending from the second end and merging with the first portion at a boundary therebetween, wherein the first portion tapers outwardly as it extends from the first end toward the boundary, and the second portion tapers outwardly to a greater extent as it extends from the boundary toward the second end.

13. A cleaning method for removing residual matter from the interior of a narrow necked container, the cleaning method comprising.
(a) providing an enclosure having an interior volume bounded at least in part by first and second ends, the first end having a first opening, and the second end having a second opening that is larger than the first opening;
(b) providing solid media;
(c) providing a first closure member;
(d) positioning the media in the interior of the narrow necked container;
(e) adding cleaning fluid to the interior of the narrow necked container;
(f) positioning the first closure member within the interior volume of the enclosure;
(g) passing at least a portion of the cleaning fluid and the media through the interior volume of the enclosure; and
(h) retaining the media within the interior volume.

14. The cleaning method according to claim 13 further comprising the step of
(i) positioning the first opening of the enclosure within the interior of the narrow necked container.

15. The cleaning method according to claim 14, wherein the method step (i) is performed before method steps (d) and (e).

16. The cleaning method according to claim 13, wherein the method step (f) is performed before method steps (g) and (h).

17. The cleaning method according to claim 14, wherein method steps (i) and (g) are performed before method steps (d) and (e).

18. A cleaning kit for removing residual matter from the interior of a narrow necked container, the cleaning kit comprising:
an enclosure having first and second interior volumes bounded at least in part by first and second sidewall portions, the first interior volume having a substantially constant diameter and being further bounded by a first opening and the second interior volume, the second interior volume being further bounded by a second opening and the first interior volume and having a constantly decreasing taper from the second opening to the first interior volume;
an solid cleaning media positioned within the second interior volume of the enclosure, said solid cleaning media being a plurality of small steel spheres;
a first closure member removably positioned to obstruct the flow of the solid cleaning media out of the enclosure through the first opening while allowing the flow of fluid from the first and second interior volumes of the enclosure through the first opening, the first closure member having a first portion comprising fibers retained between retaining wires and a second portion comprising the retaining wires formed in an arcuate shape extending into the second interior volume; and
a second closure member removably positioned to obstruct the flow of the cleaning media out of the enclosure through the second opening, the second closure member having an outside diameter greater than the outside diameter of the second sidewall portion in the region of the second end, the second closure member having at least one protrusion that engages with an outer surface of the second sidewall portion to restrict separation of the second closure member from the second sidewall portion.
